(19) United States
(12) Patent Application Publication
(10) Pub. No.: US 2026/0322693 A1
(43) Pub. Date: Oct. 15, 2026

(54) SHUTTING DOWN CLOUD NODES OF TELECOMMUNICATION NETWORK

(71) Applicant: Rakuten Symphony, Inc., Tokyo (JP)

(72) Inventors: Sree Nandan Atur, San Mateo, CA (US); Mruthyunjaya Navali, Boston, MA (US); Ashok Kumar Mishra, San Mateo, CA (US)

(21) Appl. No.: 19/374,690

(22) Filed: Oct. 30, 2025

Related U.S. Application Data
(60) Provisional application No. 63/789,005, filed on Apr. 15, 2025.

(51) Int. Cl. H04L 41/0894; H04L 43/02; H04L 43/04; H04W 24/08

(52) U.S. Cl. CPC H04L 41/0894; H04L 43/02; H04L 43/04; H04W 24/08

(57) ABSTRACT

A system includes a cloud computing platform including a plurality of nodes including a plurality of active nodes executing network functions of a telecommunication network and a plurality of standby nodes configured to perform failover in response to failure of any of the plurality of active nodes. The system includes an orchestrator configured to evaluate metrics of the telecommunication network according to a policy. The orchestrator shuts down one or more of the plurality of standby nodes when a number of the plurality of standby nodes is more than required according to the policy and the metrics. The metrics may include predicted metrics obtained by processing past metrics using a machine learning model.

### CROSS-REFERENCE TO RELATED APPLICATION

This application claims priority to U.S Provisional Application Serial No. 63/789,005 filed Apr. 15, 2025; the entire contents of which are incorporated herein by reference.

### FIELD

The present disclosure relates to shutting down cloud nodes of a telecommunication network.

### BACKGROUND

The information disclosed in this background section is only for enhancement of understanding of the general background of the disclosure and should not be taken as an acknowledgement or any form of suggestion that this information forms the prior art already known to a person skilled in the art.

The open radio access network (O-RAN) standards are non-proprietary standards used to implement hardware and software in a cellular communication network. One aspect of the O-RAN standards is a service management and orchestration (SMO) framework for implementing back-end software for managing a cellular communication network. The O-RAN O2 interface is a component that provides an interface between the SMO framework and an infrastructure management (O-Cloud) framework for supporting virtual network functions (NF) of an O-RAN network.

### SUMMARY

In one aspect, a system includes a cloud computing platform including a plurality of nodes including a plurality of active nodes executing network functions of a telecommunication network and a plurality of standby nodes configured to perform failover in response to failure of any of the plurality of active nodes. The system further includes an orchestrator configured to evaluate metrics of the telecommunication network according to a policy. The orchestrator shuts down one or more of the plurality of standby nodes when a number of the plurality of standby nodes is more than required according to the policy and the metrics.

In another aspect, a method includes evaluating, by a computer system, metrics of a telecommunication network according to a policy. The method includes (a) determining, by the computer system, that a number of a plurality of standby nodes of a plurality of nodes in a cloud-computing platform is more than required according to the metrics and the policy, the plurality of nodes including a plurality of active nodes executing network functions of the telecommunication network and a plurality of standby nodes configured to perform failover in response to failure of any of the plurality of active nodes. The method includes shutting down, by the computer system, one or more of the plurality of standby nodes in response to (a).

In another aspect, a non-transitory computer-readable medium storing executable code that, when executed by one or more processing devices, causes the one or more processing devices to: evaluate metrics of a telecommunication network according to a policy; and (a) determine that a number of a plurality of standby nodes of a plurality of nodes in a cloud-computing platform is more than required according to the metrics and a policy, the plurality of nodes including a plurality of active nodes executing network functions of the telecommunication network and a plurality of standby nodes configured to perform failover in response to failure of any of the plurality of active nodes; and shut down one or more of the plurality of standby nodes in response to (a).

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a telecommunication network including a cloud computing platform and cluster in accordance with an embodiment;

FIG. 2 is a schematic block diagram showing components for managing the shutdown of standby nodes in the cloud computing platform in accordance with an embodiment;

FIG. 3 is a process flow diagram of a method for shutting down and starting up standby nodes in accordance with an embodiment; and

FIG. 4 is a schematic block diagram of an example computing device suitable for implementing methods in accordance with embodiments of the disclosure.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

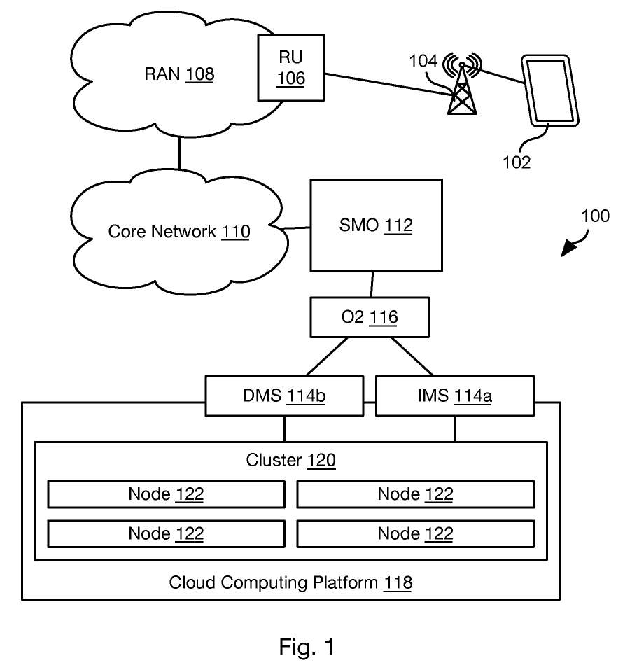

FIG. 1 illustrates an example telecommunication network 100 in which the systems and methods disclosed herein may be used. User equipment (UE) 102, such as a mobile phone, transmits wireless signals to one or more antennas 104 coupled to a radio unit (RU) 106 configured to manage generated signals to be transmitted over the antenna 104 and to detect signals received by the antenna 104. The RU 106 may be implemented as a gNodeB (gNB) in a fifth generation (5G) network, sixth generation network (6G) (e.g., a 6NB), or other type of network. The RU 106 is coupled to a radio access network (RAN) 108 including components executing RAN network functions (NF), such as a distributed unit (DU) and/or a central unit (CU) according to the Open Radio Access Network (O-RAN) standard. The RAN 108 may connect to a core network 110 implementing various core NFs, such as an access and mobility management function (AMF), user plane function (UPF), and session management function (SMF).

The RAN 108 may be coupled to a service management and orchestration (SMO) orchestrator according to the O-RAN standard (hereinafter “SMO 112”). The SMO 112 may implement various functions to manage execution of the RAN 108. For example, the SMO 112 may automatically configure, monitor, and manage failure of components of the RAN 108.

The SMO 112 may interface with an infrastructure management service (IMS) 114a that collects and reports performance measurement (PM) of infrastructure of a cloud computing platform 118 functions relating to the RAN 108. The SMO 112 may interface with the IMS 114a through an O2 interface 116 according to the O-RAN standard.

The SMO 112 may further interface with a deployment management service (DMS) 114b.

The DMS 114b may allocate resources of a cluster 120 for use by workloads executing in the cloud computing platform 118 and manage the instantiation of software components in the cluster 120 for executing the workloads. In contrast, the IMS 114a may manage the allocation of resources to the cluster 120 and the instantiation of a cluster 120 in the cloud-computing platform 118. The cluster 120 may be an O-cloud node cluster.

The cluster 120 may include a plurality of nodes 122. Each node 122 may be a virtualized unit of computing resources (processor cores, memory, storage, network bandwidth) in the cloud computing platform 118 that is available to execute workload. Each node 122 may execute one or more containers that each execute a workload. The instantiation of containers is managed by the DMS 114b. The cluster 120 may provide a framework in which the nodes 122 execute, including one or more virtual networks enabling communication between the nodes 122 and gateways for communicating with networks external to the cluster 120. The cluster 120 may further provide a framework for monitoring functioning of nodes 122, including re-instantiating failed nodes 122, scaling the number of nodes 122 up or down according to utilization, and performing other management functions. The cluster 120 may be a cluster according to KUBERNETES or other orchestration platform.

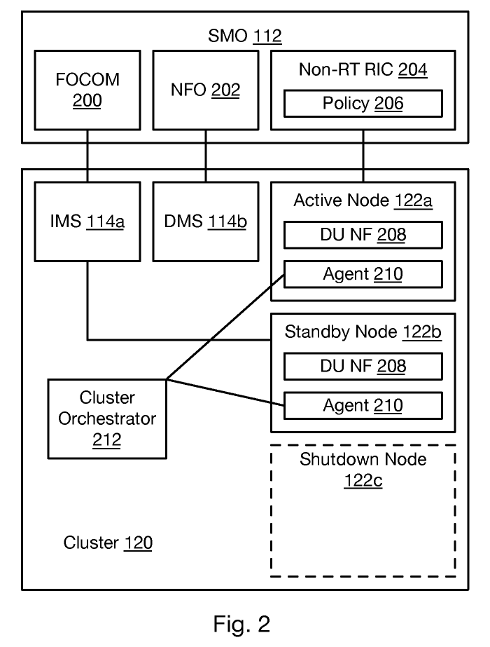

Referring to FIG. 2, the SMO 112 may implement or access a federated O-cloud orchestration and management (FOCOM) 200 and a network function orchestrator (NFO) 202. The FOCOM 200 performs high-level management of the infrastructure of the cloud-computing platform 118 including managing inventory and processing alerts. The NFO 202 may perform life cycle management of network functions (NF) that are deployed in the cloud-computing platform 118.

The FOCOM 200 may interface with the IMS 114a to add nodes to a cluster 120, such as detecting when a new node is physically added, initialize the new node, and allocate the new node to the cluster 120. The DMS 114b may interface with the NFO 202 to deploy NFs on the nodes 122 of a cluster 120, such as the illustrated distributed unit NF (DU NF) 208.

The SMO 112 may implement or access a non-real-time radio intelligent controller (RIC) (non-RT RIC) 204. The non-RT RIC 204 may perform non-time-critical functions with respect to the RAN 108, such as providing policy guidance, managing RAN applications (rApps), training machine learning models with data from the RAN, performing network analytics for improving the RAN, or other functions. The non-RT RIC 204 may generate a policy 206 according to the approach described herein for determining when to shut down or start up nodes 122 of the cluster 120.

Each node 122 of the cluster 120, such as the illustrated active node 122a and standby node 122b may execute an agent 210. The agent 210 may be an agent of the cluster 120, such as a cluster orchestrator 212 implementing the cluster 120. The cluster orchestrator 212 may, for example, be a KUBERNETES control plane and/or other type of orchestrator. For example, the cloud-computing platform 118 may be implemented by a cloud orchestrator while the cluster 120 is implemented by the cluster orchestrator 212.

The active node 122a may execute process data from the telecommunication network 100 using a network function, such as the illustrated DU NF 208. The standby node 122b is turned on and may host a network function but is not functioning to process data from the telecommunication network 100. In some embodiments, a network function is absent from the standby node 122b and is instantiated when the standby node 122b becomes the active node, such as in response to failure of the active node 122a. There may be any number of active nodes 122a and standby nodes 122b.

As discussed in detail below, one or more nodes 122 of the cloud computing platform 118 may be shut down when not in use, such as the illustrated shutdown node 122c. As used herein shutting down a node 122 may include switching off power to all components of the node 122 other than those required to remotely turn on the components of the node 122 that have been switched off. For example, a board management controller (BMC) may remain powered on while the node 122 is shut down. A network function may be installed on the shutdown node 122c or may be instantiated after the shutdown node 122c is turned on and becomes a standby node 122b or an active node 122a.

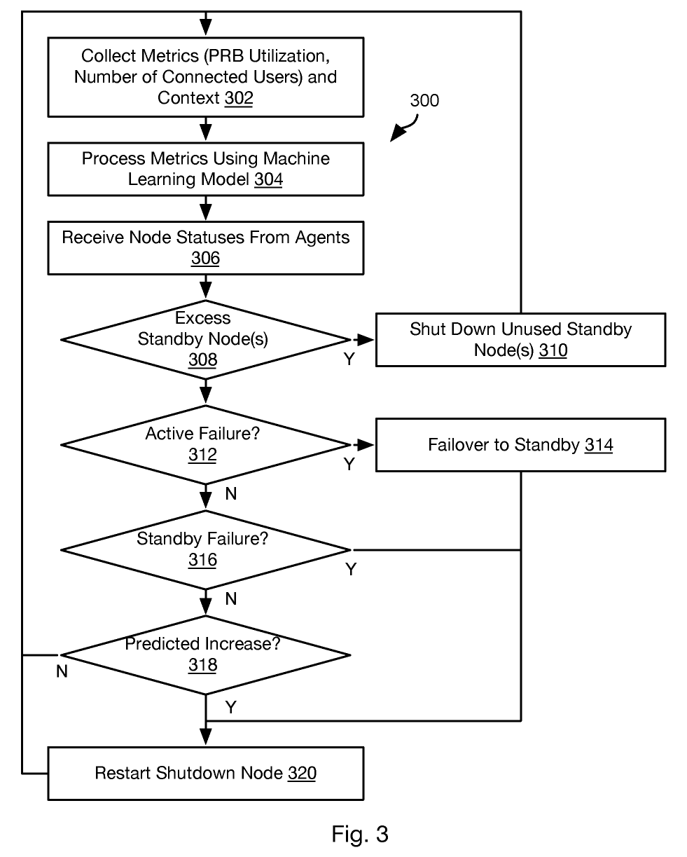

FIG. 3 illustrates a method 300 that may be performed in the telecommunication network 100 in order to shutdown nodes 122 that are not in use. In some embodiments, the method 300 may be executed by the non-RT RIC 204 with actions performed by other components as indicated below.

The method 300 may be preceded by training a machine learning model. The machine learning model may take in historical time series data for a past time period and output predicted time series data for a time period extending into the future. The historical and predicted time series data may include values for metrics describing usage of the telecommunication network, such as physical resource block (PRB) utilization, number of connected users, or other time series data.

The machine learning model may be trained with collected time series data for the metrics that are collected for the telecommunication network 100 over an extended period, such as weeks, months, or some other period. A first portion of the collected time series data for a first time period may be processed using the machine learning model to obtain predicted time series data for a second time period following the first time period. A training algorithm may compare the predicted time series data to a second portion of the collected time series data for the second time period. The training algorithm may then update the machine learning model according to the comparison. Inputs to the machine learning model for the collected time series data for the first time period may include context information such as a time of day, day of the week, day of the year, or other information.

The machine learning model may be implemented as a logistic regression model, binary tree model, neural network, deep neural network, convolution neural network, Bayesian network genetic algorithm, or other type of machine learning model.

Collecting of the collected time series data and training of the machine learning model may be performed by the FOCOM 200. The FOCOM 200 may receive the collected time series data from network functions of the telecommunication network such as DU NFs 208.

The method 300 may include collecting, at step 302 metrics for the telecommunication network, such as any of the time series data described above. The metrics collected at step 302 may be collected for a past time window ending approximately at or before a current time, such as a time of performance of the method 300, such as within 1 minute, 10 seconds, 1 second, or some other interval. The collected data may be collected over the O1 interface from network functions (e.g., the DU NF 208) executing on the active nodes 122a. Collection of data may be performed by an rAPP of the non-RT RIC 204.

The method 300 may include processing, at step 304, the metrics from step 302 using the machine learning model to obtain predicted time series data for a future time window following the current time. The processing of step 304 may include processing context data using the machine learning model, such as a current time of day, day of the week, day of the year, or other information describing the current context of the telecommunication network 100.

The method 300 may include receiving, at step 306, node statuses from the agents 210 of any properly functioning nodes 122a, such as each active node 122a and standby node 122b that is functioning and has a connection to the SMO 112. Each agent 210 may communicate the status of the node 122a, 122b executing the agent 210 to the SMO 112 by, for example, transmitting the status of the node 122a, 122b through an O2 interface to the non-RT RIC 204 directly or by way of the cluster orchestrator 212. The agents 210 may transmit statuses periodically, when prompted by an external signal, such as from the non-RT RIC 204, or in response to some other event. Step 306 may include identifying any active node 122a or standby node 122b from which a status was not received or for which the received status indicated failure of the node 122a, 122b. Accordingly, following step 306, the non-RT RIC 204 has an inventory of all active nodes 122a and standby nodes 122b that are operational and reachable.

The method 300 may include evaluating, at step 308 whether the number of operational and reachable active nodes 122a and standby nodes 122b indicates one or more standby nodes 122b are not needed. Step 308 may include evaluating the number of operational and reachable active nodes 122a and standby nodes 122b in view of the predicted time series data from step 304 and the policy 206.

For example, bringing up a shutdown node 122c may be a relatively long process. For example, a startup time TS may include the time required for the shutdown node 122c to become operational from a shutdown state. The startup time TS may include the time required for the shutdown node 122c to startup, be configured, install a network function, configure the network function, configure other nodes to communicate with the network function, and possibly other tasks. Step 308 may include determining that for a time period N*TS in the future from the current time (e.g., the time of execution of step 308 or some other reference time), the predicted time series data indicates that the number of operational and reachable standby nodes 122b is more than required according to the policy 206, where N is a number greater than one, such as 2, 3, 4 or more times the startup time TS. For example, TS may be on the order of 15 minutes, and N may be on the order of 4, 8, 16, or more such that N*TS is 1, 2, 4, or more hours.

The policy 206 may specify a minimum number of active nodes 122a and standby nodes 122b for a given set of metric values (e.g., physical resource block (PRB) utilization, number of connected users, or other time series data). Step 308 therefore includes determining whether the minimum number of operational and reachable standby nodes 122b required by the policy 206 for the predicted time series data during the entire N*TS time period is greater than the current number of operational and reachable standby nodes 122b. The policy 206 may define exclusions, minimums, or other values that are independent of metrics. For example, for some times of day or days of the week, a minimum number of standby nodes 122b must be kept available regardless of loading of the telecommunication network. In another example, critical infrastructure (e.g., a hospital) may require a minimum number of standby nodes 122b regardless of the metrics.

If the number of operational and reachable standby nodes 122b is found to be excessive at step 308, then one or more of the standby nodes 122b may be shutdown at step 310, such as the number of standby nodes 122b that are in excess of the minimum number required according to the policy 206 as described above. Shutting down a standby node 122b may include notifying the DMS 114b to remove the standby node 122b from the cluster 120. Shutting down a standby node 122b may include instructing the IMS 114a to shut down the standby node 122b.

In the event that step 306 is found, at step 312, to indicate that an active node 122a has failed, the method 300 may including performing, at step 314, failover to an operational and reachable standby node 122b. Detecting failure at step 312 and performing failover at step 314 may be performed by the cluster orchestrator 212 or some other component. For example, KUBERNETES provides the ability to automatically perform failover. As used herein, “failure” of a node may indicate that the node is not operational or not reachable over a network connection. As used herein “failover” includes commencing performing the functions formerly performed by a failed node 122a on the standby node 122b.

Various events may result in the number of standby nodes 122b being deficient according to the metrics and the policy. For example, an active node 122a may be found to have failed at step 312 such that the total number of active nodes 122a and operational and reachable standby nodes 122b is less than required according to the policy (see step 308). One or more standby nodes 122b may be found to have failed at step 316 such that the number of standby nodes 122b is less than that required according to the policy. The predicted time series data may be found, at step 318, to indicate that the current number of standby nodes 122b is less than the minimum required according to the policy. In response to any of the cases of steps 312, 316, 318 being true, the method 300 may include restarting one or more shutdown nodes 122c at step 320 such that the number of standby nodes 122b is sufficient according to the metrics and the policy.

Restarting a shutdown node 122c may include invoking restarting of the shutdown node 122c by the IMS 114a, such as by instructing the IMS 114a to restart the shutdown node 122c, such as by sending a signal to a board management controller (BMC) of the shutdown node 122c. Restarting a node may include installing and configuring software, establishing network connections, or performing other functions. Once the shutdown node 122c is restarted, the DMS 114b may add the shutdown node 122c to the cluster and the cluster orchestrator 212. At this point the shutdown node 122c may be effectively a standby node 122b. In other embodiments, step 320 may further include installing a network function on the shutdown node 122c, such as the DU NF 208.

The method 300 may be executed repeatedly during operation of the telecommunication network in order to adjust the number of standby nodes 122b. By shutting down excessive standby nodes, the amount of power consumption by the cloud computing platform 118 may be reduced, particularly during low-traffic time periods, thereby reducing the operational costs of the telecommunication network 100.

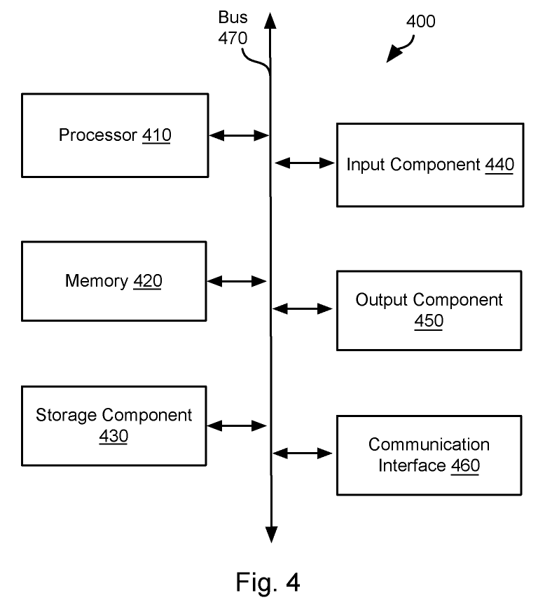

FIG. 4 illustrates an embodiment of a computing device 400 that may be used to implement any of the computing components described above. As shown in FIG. 4, the device 400 includes processor 410, a memory 420, a storage component 430, an input component 440, an output component 450, a communication interface 460, and a bus 470.

The processor 410, as used herein, means any type of computational circuit that may comprise hardware elements and software elements. The processor 410 may be embodied as a multi-core processor, a single core processor, or a combination of one or more multi-core processors and/or one or more single core processors, a distributed processing system, or the like. The processor 410 may be a Central Processing Unit (CPU), a graphics processing unit (GPU), an accelerated processing unit (APU), an application-specific integrated circuit (ASIC), or another type of processing component.

Memory 420 includes a non-transitory computer readable medium. Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 cause the processor 410 to perform one or more method steps of an embodiment described above.

Storage component 430 stores information and/or software related to the operation and use of the device 400. For example, storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 440 is configured to receive information, such as user input. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

Output component 450 is configured to provide output information from the device 400. For example, the output component 450 may be, but not limited to, a display, a speaker, instructions to an external device, and/or one or more light-emitting diodes (LEDs).

Communication interface 460 is an interface that provides a communication connection to other devices, such as external devices and internal devices. The connection by the communication interface 460 can be a wired connection, a wireless connection, or a combination of wired and wireless connections, and can be a direct connection or an indirect connection via a communication network that exists between the device 400 and other devices. In other words, the standard of the communication interface 460 is not limited.

The bus 470 acts as an interconnect between the processor 410, the memory 420, the storage component 430, the input component 440, the output component 450, and the communication interface 460 of the device 400. The bus 470 may include a wired interconnection or a wireless interconnection.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400. Further, one or more method steps described in any of the embodiments may be performed utilizing a plurality of devices 400 in communication with one another.

In a first example embodiment, a system includes: a cloud computing platform including a plurality of nodes including a plurality of active nodes executing network functions of a telecommunication network and a plurality of standby nodes configured to perform failover in response to failure of any of the plurality of active nodes; and an orchestrator configured to: evaluate metrics of the telecommunication network according to a policy; and shut down one or more of the plurality of standby nodes when a number of the plurality of standby nodes is more than required according to the policy and the metrics.

In a second example embodiment according to the first example embodiment, the metrics include a number of connected users.

In a third example embodiment according to the first example embodiment, the metrics include physical resource block (PRB) utilization.

In a fourth example embodiment according to the first example embodiment, the metrics include both of a number of connected users and physical resource block (PRB) utilization.

In a fifth example embodiment according to the first example embodiment: the metrics include collected time series data for a past time window preceding a current time; and the orchestrator is configured to evaluate the metrics by: processing the collected time series data

using a machine learning model to obtain predicted time series data for a future time window following the current time; evaluating the predicted time series data with respect to the policy; and shutting down the one or more of the plurality of standby nodes when the number of the plurality of standby nodes is more than required according to the policy and the predicted time series data.

In a sixth embodiment according to the fifth example embodiment, a shutdown node of the plurality of nodes has a startup time TS; and the orchestrator is configured to shut down the one or more of the plurality of standby nodes when the number of the plurality of standby nodes is more than required according to the policy and the predicted time series data for a period N*TS after the current time, where N is greater than one.

In a seventh example embodiment according to the sixth example embodiment, N*TS is at least one hour.

In an eighth example embodiment according to the seventh example embodiment, N*TS is at least two hours.

In a ninth example embodiment according to the first example embodiment, the orchestrator is further configured to: invoke startup of a shutdown node of the plurality of nodes in response to the number of the plurality of standby nodes being less than required according to the metrics and the policy.

In a tenth example embodiment according to the first example embodiment, the orchestrator is a service management and orchestration (SMO) orchestrator.

In an eleventh example embodiment according to the first example embodiment, the telecommunication network includes a radio access network (RAN) and the network functions include a distributed unit network function (DU-NF).

In a twelfth example embodiment, a method includes: evaluating, by a computer system, metrics of a telecommunication network according to a policy; and (a) determining, by the computer system, that a number of a plurality of standby nodes of a plurality of nodes in a cloud-computing platform is more than required according to the metrics and the policy, the plurality of nodes including a plurality of active nodes executing network functions of the telecommunication network and a plurality of standby nodes configured to perform failover in response to failure of any of the plurality of active nodes; and shutting down, by the computer system, one or more of the plurality of standby nodes in response to (a).

In a thirteenth example embodiment according to the twelfth example embodiment, the metrics include both of a number of connected users and physical resource block (PRB) utilization.

In a fourteenth example embodiment according to the twelfth example embodiment: the metrics include collected time series data for a past time window preceding a current time; and the method further comprising evaluating, by the computer system, the metrics by: processing the collected time series data using a machine learning model to obtain predicted time series data for a future time window following the current time; evaluating the predicted time series data with respect to the policy; and shutting down the one or more of the plurality of standby nodes when the number of the plurality of standby nodes is more than required according to the policy and the predicted time series data.

In a fifteenth example embodiment according to the fourteenth example embodiment: a shutdown node of the plurality of nodes has a startup time TS; and the method further comprises shutting down, by the computer system, the one or more of the plurality of standby nodes when the number of the plurality of standby nodes is more than required according to the policy and

the predicted time series data for a period N*TS after the current time, where N is greater than one.

In a sixteenth example embodiment according to the fifteenth example embodiment, N*TS is at least one hour.

In a seventeenth example embodiment according to the twelfth example embodiment, the method further includes invoking, by the computer system, startup of a shutdown node of the plurality of nodes in response to the number of the plurality of standby nodes being less than required according to the metrics and the policy.

In an eighteenth example embodiment according to the twelfth example embodiment, the method is performed by a service management and orchestration (SMO) orchestrator executing on the computer system.

In a nineteenth example embodiment according to the twelfth example embodiment, the telecommunication network includes a radio access network (RAN) and the network functions include a distributed unit network function (DU-NF).

In a twentieth example embodiment, a non-transitory computer-readable medium storing executable code that, when executed by one or more processing devices, causes the one or more processing devices to: evaluate metrics of a telecommunication network according to a policy; and (a) determine that a number of a plurality of standby nodes of a plurality of nodes in a cloud-computing platform is more than required according to the metrics and a policy, the plurality of nodes including a plurality of active nodes executing network functions of the telecommunication network and a plurality of standby nodes configured to perform failover in response to failure of any of the plurality of active nodes; and shut down one or more of the plurality of standby nodes in response to (a).

1. A system comprising:
a cloud computing platform including a plurality of nodes including a plurality of active nodes executing network functions of a telecommunication network and a plurality of standby nodes configured to perform failover in response to failure of any of the plurality of active nodes; and
an orchestrator configured to:
evaluate metrics of the telecommunication network according to a policy; and
shut down one or more of the plurality of standby nodes when a number of the plurality of standby nodes is more than required according to the policy and the metrics.

2. The system of claim 1, wherein the metrics include a number of connected users.

3. The system of claim 1, wherein the metrics include physical resource block (PRB) utilization.

4. The system of claim 1, wherein the metrics include both of a number of connected users and physical resource block (PRB) utilization.

5. The system of claim 1, wherein:
the metrics include collected time series data for a past time window preceding a current time; and
the orchestrator is configured to evaluate the metrics by:
processing the collected time series data using a machine learning model to obtain predicted time series data for a future time window following the current time;
evaluating the predicted time series data with respect to the policy; and
shutting down the one or more of the plurality of standby nodes when the number of the plurality of standby nodes is more than required according to the policy and the predicted time series data.

6. The system of claim 5, wherein:
a shutdown node of the plurality of nodes has a startup time TS; and
the orchestrator is configured to shut down the one or more of the plurality of standby nodes when the number of the plurality of standby nodes is more than required according to the policy and the predicted time series data for a period N*TS after the current time, where N is greater than one.

7. The system of claim 6, wherein N*TS is at least one hour.

8. The system of claim 7, wherein N*TS is at least two hours.

9. The system of claim 1, wherein the orchestrator is further configured to:
invoke startup of a shutdown node of the plurality of nodes in response to the number of the plurality of standby nodes being less than required according to the metrics and the policy.

10. The system of claim 1, wherein the orchestrator is a service management and orchestration (SMO) orchestrator.

11. The system of claim 1, wherein the telecommunication network includes a radio access network (RAN) and the network functions include a distributed unit network function (DU-NF).

12. A method comprising:
evaluating, by a computer system, metrics of a telecommunication network according to a policy; and
(a) determining, by the computer system, that a number of a plurality of standby nodes of a plurality of nodes in a cloud-computing platform is more than required according to the metrics and the policy, the plurality of nodes including a plurality of active nodes executing network functions of the telecommunication network and a plurality of standby nodes configured to perform failover in response to failure of any of the plurality of active nodes; and
shutting down, by the computer system, one or more of the plurality of standby nodes in response to (a).

13. The method of claim 12, wherein the metrics include both of a number of connected users and physical resource block (PRB) utilization.

14. The method of claim 12, wherein:
the metrics include collected time series data for a past time window preceding a current time; and
the method further comprising evaluating, by the computer system, the metrics by:
processing the collected time series data using a machine learning model to obtain predicted time series data for a future time window following the current time;
evaluating the predicted time series data with respect to the policy; and
shutting down the one or more of the plurality of standby nodes when the number of the plurality of standby nodes is more than required according to the policy and the predicted time series data.

15. The method of claim 14, wherein:
a shutdown node of the plurality of nodes has a startup time TS; and
the method further comprises shutting down, by the computer system, the one or more of the plurality of standby nodes when the number of the plurality of standby nodes is more than required according to the policy and the predicted time series data for a period N*TS after the current time, where N is greater than one.

16. The method of claim 15, wherein N*TS is at least one hour.

17. The method of claim 12, further comprising:
invoking, by the computer system, startup of a shutdown node of the plurality of nodes in response to the number of the plurality of standby nodes being less than required according to the metrics and the policy.

18. The method of claim 12, wherein the method is performed by a service management and orchestration (SMO) orchestrator executing on the computer system.

19. The method of claim 12, wherein the telecommunication network includes a radio access network (RAN) and the network functions include a distributed unit network function (DU-NF).

20. A non-transitory computer-readable medium storing executable code that, when executed by one or more processing devices, causes the one or more processing devices to:
evaluate metrics of a telecommunication network according to a policy; and
(a) determine that a number of a plurality of standby nodes of a plurality of nodes in a cloud-computing platform is more than required according to the metrics and a policy, the plurality of nodes including a plurality of active nodes executing network functions of the telecommunication network and a plurality of standby nodes configured to perform failover in response to failure of any of the plurality of active nodes; and
shut down one or more of the plurality of standby nodes in response to (a).
